(19) United States
(12) Patent Application Publication
(10) Pub. No.: US 2007/0183949 A1
(43) Pub. Date: Aug. 9, 2007

(54) Hydrocarbon reformer system including a pleated static mixer

(76) Inventor: Bernhard A. Fischer, Rochester, NY (US)

Correspondence Address: DELPHI TECHNOLOGIES, INC., M/C 480-410-202, PO BOX 5052, TROY, MI, 48007, US

(21) Appl. No.: 11/350,366

(22) Filed: Feb. 8, 2006

(51) Int. Cl. B01J 19/00; B01J 8/02; B01F 5/06

(52) U.S. Cl. 422/224; 422/211; 366/336

(57) ABSTRACT

A hydrocarbon reformer system for a fuel cell system comprising a feedstream delivery unit (FDU) and a hydrocarbon catalytic reformer (CR). The reformer includes a catalyst disposed in a housing. Ahead of the catalyst is the FDU including a static mixer for receiving any or all of air, hydrocarbon fuel, anode tailgas, and steam. The mixer is pleated and perforated, forming a plurality of flow passages between first and second sides of the mixer. Fuel flows through the perforations and is jetted into the reactants at a very large number of flow passage locations, wherein mixing occurs instantly. Homogenized fuel/reactants leave the mixer in a sheet flow nearly uniform in temperature that enters the reformer catalyst and allows uniform catalysis over the entire catalyst surface.

The present invention relates to hydrocarbon reformers for producing fuel for fuel cells; more particularly, to such a reformer that utilizes the anode tailgas stream from an associated fuel cell system; and most particularly, to a reformer system having a pleated static mixer ahead of the reformer catalyst for passive, laminar or turbulent mixing of fuel, anode tailgas, air, and/or steam.

### BACKGROUND OF THE INVENTION

Partial catalytic oxidizing (CPOx) reformers are well known in the art as devices for converting hydrocarbons to reformate containing hydrogen (H₂) and carbon monoxide (CO) as fuel for fuel cell systems, and especially for solid oxide fuel cell (SOFC) systems.

Because a fuel cell is a relatively inefficient combustor, the anode tail gas stream exiting an SOFC stack is typically rich in H₂O, CO₂, and also a substantial amount of residual CO and H₂. Venting or burning the anode tail gas is wasteful and directly affects the overall fuel efficiency of the fuel cell system. To increase overall fuel efficiency, it is known in the art to recycle a portion of the anode tail gas back into the reformer, which improves efficiency in two ways: a) by passing the residual hydrogen and carbon monoxide through the stack again, and b) by providing beneficial heat from the stack to the reformer. Recycling anode tail gas through the stack allows apparent reformer efficiencies in excess of 100%. Further, when temperatures in the reformer are sufficiently high, fuel reforming may proceed adiabatically through decomposition of fuel with water and carbon dioxide without addition of outside oxygen in the form of air. Reforming efficiencies greater than 99% of the possible thermodynamic efficiency are calculated and tested as possible, given sufficient heat recovery into the entering reactants from the stack and reformer catalyst.

Although it is known in the art to inject tailgas into the air stream and fuel stream being supplied to a reformer, the prior art has not focused on optimizing the mixing of the various streams before sending the mixture into the reformer, nor on highly efficient heat extraction from the reformer catalyst. As a result, prior art mixtures are inhomogeneous, leading to large areal variations in reformer catalysis, carbon buildup in the reformer, extreme thermal stresses within the catalyst, and inefficient reformate generation. Further, many problems in fuel reformer mixture preparation result from autoignition and flashback of the reactants in the mixing channels upstream of the catalyst in reforming mode. These problems usually result from recirculating flow features or boundary conditions at the walls in the fuel feed preparation unit and the hot catalyst face.

Further, prior art reformer arrangements have not focused on optimizing not only steady state operation but also on the temporary but important periods of system start-up and transition to steady-state.

What is needed is a hydrocarbon reformer system that provides very high fuel efficiency; can be started up very rapidly without carbonizing of the catalyst; improves thermal efficiency by internally recycling heat of catalysis; prevents autoignition and flashback during steady state operation; and is operable over a wide range of reformate demand.

It is a principal object of the present invention to improve fuel efficiency.

It is a further object of the invention to homogenize combined gases being fed to a reformer.

### SUMMARY OF THE INVENTION

Briefly described, a hydrocarbon reformer system in accordance with the invention comprises two main sections: a feedstream delivery unit (FDU) and a hydrocarbon catalytic reformer (CR). The reformer includes a hydrocarbon-reforming catalyst disposed in a reforming chamber in an elongate housing. Ahead of the catalyst is the FDU including a static mixer for receiving any or all of air, hydrocarbon fuel, anode tailgas, and steam. The static mixer includes a pleated mixing portion conveying two separated streams of gaseous reactants, preferably hydrocarbon fuel as a first stream and a combination of non-fuel reactants as a second stream, and having a plurality of orifices through the pleats allowing the gas at higher pressure, preferably the hydrocarbon fuel, to be jetted into the flowing stream of the gas at lower pressure in a plurality of jets, producing a stratified flow field. The pleated structure, having a large plurality of small orifices at the interface between the fuel and the other reactants, prevents autoignition and flashback of the mixture similar to the operation of a perforated flame arrester. Homogenized reactants leave the pleated mixer in a sheet flow nearly uniform in temperature, velocity, and mixture that enters the catalyst and allows uniform catalysis over the entire catalyst surface.

Preferably, at start-up the fuel/air mixture in the mixer is enriched by additional injection of fuel, creating a combustible mixture downstream of the mixer which is ignited and then continues to propagate. The hot combustion gases raise the catalyst to reforming temperature in a few seconds. Combustion is then quenched by cessation of fuel flow for a short period, after which the fuel/air ratio is adjusted for optimum reforming.

### BRIEF DESCRIPTION OF THE DRAWINGS

The present invention will now be described, by way of example, with reference to the accompanying drawings, in which:

FIG. 1 is a schematic diagram of a solid oxide fuel cell system including a hydrocarbon reformer system having a pleated static mixer in accordance with the invention;

FIG. 2 is an isometric view of an exemplary pleated static mixer in accordance with the invention;

FIG. 3 is an elevational cross-sectional view of the pleated static mixer shown in FIG. 2; and

FIG. 4 is an exploded isometric view of an exemplary three-component pleated static mixer in accordance with the invention.

### DESCRIPTION OF THE PREFERRED EMBODIMENTS

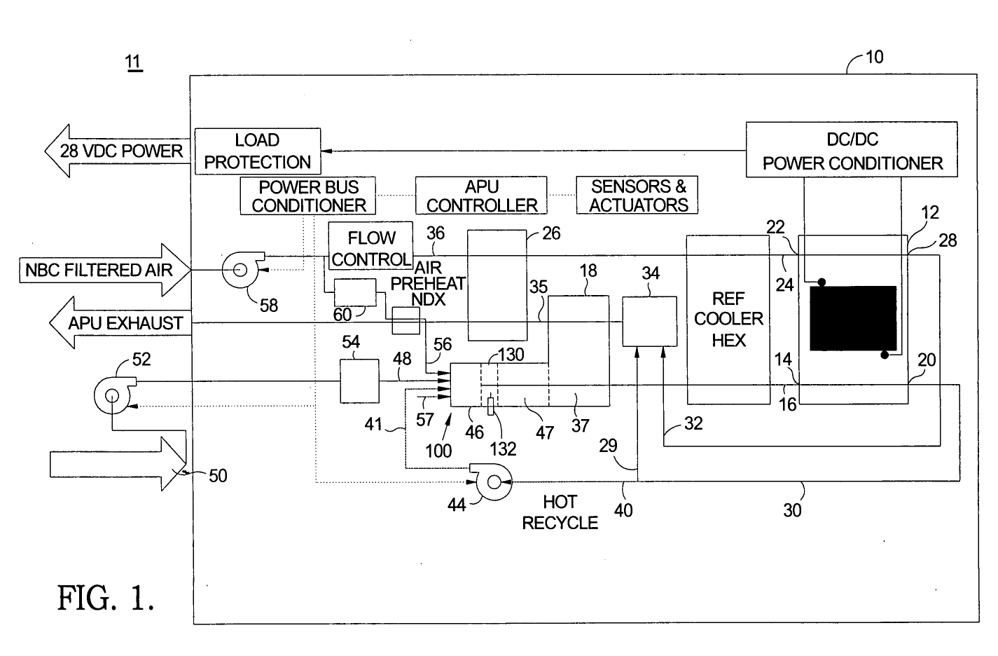

Referring to FIG. 1, an SOFC system 10 in accordance with the invention comprises an SOFC stack 12 having an anode inlet 14 for reformate 16 from a CPOx reformer system 18 in accordance with the invention; an anode tail gas outlet 20; an inlet 22 for heated cathode air 24 from a cathode air heat exchanger 26; and a cathode air outlet 28. SOFC system 10 is useful, for example, as an auxiliary power unit (APU) in a vehicle 11.

A first portion 29 of anode tail gas 30 and spent cathode air 32 are fed to a burner 34, the hot exhaust 35 from which optionally is passed through a reformer heat exchanger 37, to partially cool the reformer, and through cathode air heat exchanger 26 to heat the incoming cathode air 36. A second portion 40 of anode tail gas 30 is diverted ahead of burner 34 to an anode tail gas pump 44 which directs cooled portion 41 of anode tail gas into an entrance to a feedstock delivery unit (FDU) 46 ahead of a catalytic reforming unit 47 in reformer system 18. Thus residual hydrocarbons in the anode tail gas are exposed to reforming for a second time, and heat is recovered in both the reformer and the cathode air heater. FDU 46 is further supplied with fuel 48 via a fuel tank 50, a fuel pump 52, and a fuel flow metering system 54. FDU 46 is further supplied optionally with air 56 via a process air blower 58 and air flow metering system 60.

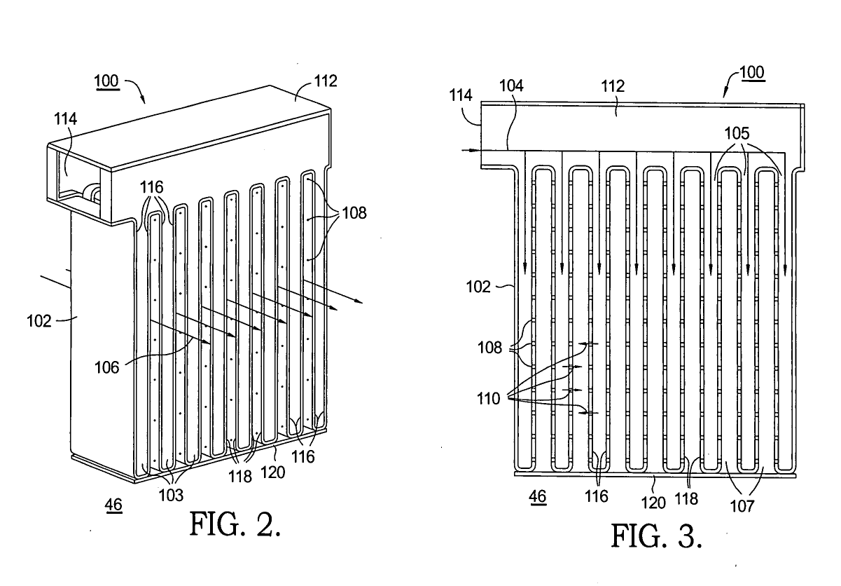

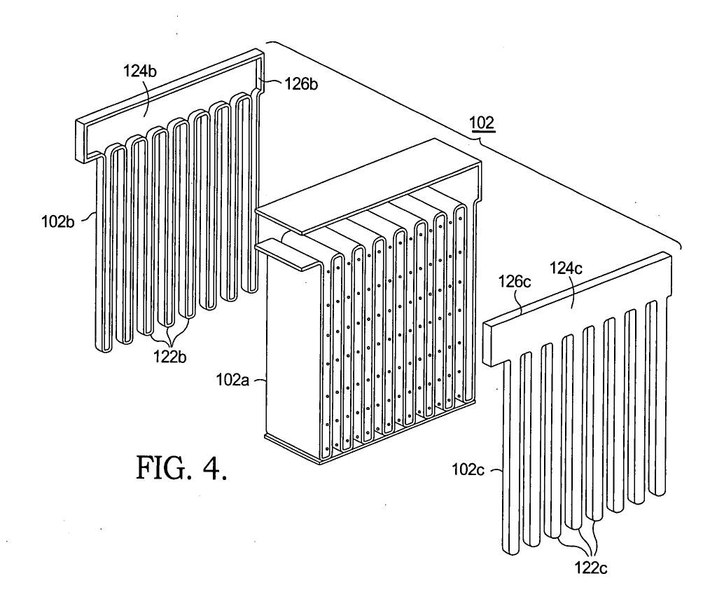

Referring to FIGS. 1 through 4, FDU 46 includes a static mixer 100 for mixing fuel 48 with any or all of anode tailgas 41, air 56, and optional steam 57. Mixer 100 comprises a perforated metal septum 102 separating a first fluid flow stream 104 from a second fluid flow stream 106. A plurality of orifices 108 in septum 102 allow fluid flow as a plurality of jets 110 through the septum from a higher pressure side to a lower pressure side. Orifices 108 are preferably formed as an array of circular holes, although other configurations such as slots are fully anticipated by the invention.

In forming presently preferred mixer embodiment 100, an elongated strip of septum 102 is folded into a plurality of pleats 103 such that first and second chambers are formed as a plurality of interleaved fingers 105,107. Pleats 103 to provide a large septum surface and a large number of orifices 108 in a relatively compact device. The folding also provides a plenum 112 for receiving fluid flow through an entrance 114 and distributing fluid, preferably substantially equally, into the first sides 116 of several pleats for transmission through orifices 108 to second sides 118. The pleats are connected at their distal ends by an end member 120 thereby forming a plurality of flow passages comprising second sides 118 to exhaust the mixture of first and second fluids from mixer 100. Of course if desired, end member 120 may be off-spaced from the pleats to create a second manifold (not shown) similar to first manifold 112.

Referring to FIG. 4, a pleated mixer in accordance with the invention may be readily and inexpensively formed of as few as three components, shown as 102a, 102b, and 102c in FIG. 4. Component 102a is a folded, perforated septum as just described above. Component 102b is a first endcap, and component 102c is a second and opposed endcap, both formed of a suitable metal. Endcaps 102b,102c include fingers 122b,122c respectively that cover flow spaces 116, and also include plenum sidewalls 124b,124c that complete plenum 112. The fingers and sidewalls are defined by peripheral flanges 126b,126c that extend over the edges of septum 102a when assembled thereto and permit continuous sealing of the endcaps to the septum as by conventional welding, soldering, or brazing (not shown).

Presently preferred hydrocarbon fuels for SOFC system 10 are either gaseous, such as methane, propane, natural gas, and the like, or are readily volatilized via heat exchange (not shown) prior to being introduced into FDU 46.

In a presently preferred embodiment, the diameter of orifices is between about 0.05 mm and about 2.0 mm, and the width of flow pleats 103 is between about 0.3 mm and about 5.0 mm.

In operation during system start-up mode, FDU 46 functions as a combustion chamber. Air and fuel are introduced into and combined in static mixer 100. Preferably, gaseous fuel is introduced into plenum 112 as fluid flow 104 at a first pressure, and air is passed through the mixer as fluid flow 106 at a second and lower pressure, such that gaseous fuel flows through orifices 108 as jets 110. Because of the large number of jets 110 and because they are uniformly distributed in the various sheet flows of fluid 106 through mixer 100, the fuel is divided into the large number of jets, enters the flowing air at a large number of places, and is mixed by turbulence instantly into the flowing air, thus producing an air/fuel mixture which is of uniform composition and homogeneity over the entire exit plane of the mixer. The arrangement of the mixer is modular and thus is easy to adapt to varying design and operating parameters and is insensitive to overall size and flow demand.

As the homogenized air/fuel mixture passes into an antechamber 130 ahead of reformer 47 it is ignited by ignitor 132 (FIG. 1) to form hot combustion gases in antechamber 130 that are then passed through the reformer catalyst bed. Combustion continues spontaneously in antechamber 130 for a predetermined length of time, for example, about ten seconds, generating thereby a continuous flow of hot gases through the catalyst bed sufficient to bring the catalyst bed to reforming temperature. Combustion is extinguished by shutting off the flow of fuel for a brief period, for example, one second.

In operation during steady-state mode, fuel is provided to plenum 112 and flow pleats 103 as first flow stream 104 and anode tailgas 41 is provided as second fluid 106. In exothermic reforming, air 56 is also supplied as a component of second fluid 106, and the fuel/air mixture is sufficiently lean and uniform that spontaneous combustion does not occur within either the static mixer or the reformer. Heat of reforming, radiated from the catalyst bed, is partly absorbed by static mixer 100. The absorbed heat is transferred to the incoming fuel and other reactants, thus recovering significant heat energy and providing a heat sink for the catalyst bed. As overall temperature of the system increases, the flow of air 56 may be reduced as reforming becomes more endothermic, utilizing the carbon dioxide and water content of the anode tailgas. Under conditions in which the tailgas water volume is insufficient, steam may be added to the mix (by conventional means not shown).

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A hydrocarbon reformer system, comprising
a) a reforming unit for reforming hydrocarbon fuel into reformate containing hydrogen and carbon monoxide, said reforming unit including a reforming catalyst bed; and
b) a feedstream delivery unit for homogenizing and tempering various reactants to be supplied to said catalytic reforming unit, said feedstream delivery unit including a pleated static mixer wherein said various reactants are mixed.

2. A reformer system in accordance with claim 1 wherein said pleated static mixer includes a pleated septum separating first and second fluids in first and second fluid flow paths, respectively, through said mixer.

3. A reformer system in accordance with claim 2 wherein said pleated septum includes a plurality of orifices providing fluid communication between said first and second fluid flow paths.

4. A reformer system in accordance with claim 2 wherein said pleated static mixer further comprises a manifold for supplying fluid to one of said first or second fluid flow paths.

5. A reformer system in accordance with claim 2 wherein one of said first or second fluids is a hydrocarbon fuel and the other is a non-hydrocarbon reactant selected from the group consisting of air, anode tailgas, steam, and combinations thereof.

6. A reformer system in accordance with claim 1 further comprising an igniter disposed between said pleated static mixer and said reforming catalyst bed.

7. A solid oxide fuel cell system comprising a hydrocarbon reformer system, wherein said hydrocarbon reformer system includes
a reforming unit for reforming hydrocarbon fuel into reformate containing hydrogen and carbon monoxide, said reforming unit including a reforming catalyst bed, and
a feedstream delivery unit for mixing various reactants to be supplied to said catalytic reforming unit, said feedstream delivery unit including a pleated static mixer wherein said various reactants are mixed.

8. A method for providing a homogenous feedstream mixture of hydrocarbon fuel and other reactants to a hydrocarbon catalytic reformer, comprising the steps of:
a) providing a pleated static mixer having a plurality of orifices in fluid communication between first and second sides of said pleated static mixer;
b) entering said hydrocarbon fuel into one of said first or second sides of said pleated static mixer;
c) entering said various other reactants into the other of said first or second sides of said pleated static mixer;
d) forcing one of said hydrocarbon fuel and said various other reactants through said plurality of orifices to cause mixing thereof with the other of said hydrocarbon fuel and said various other reactants to produce a homogenized feedstream combination; and
e) providing said homogenized feedstream combination to said hydrocarbon catalytic reformer.

9. A method in accordance with claim 8 wherein said other reactants are selected from the group consisting of air, anode tailgas, steam, and combinations thereof.

10. A static mixer for mixing a first fluid into a second fluid, comprising:
a) a septum defining separate first and second chambers for said first fluid and said second fluid;
b) a plurality of orifices extending through said septum in communication between said first and second chambers;
wherein said septum defines a plurality or pleats; and
wherein said plurality of pleats define a plurality of interleaved fingers; and
wherein said first fluid flow through said plurality of orifices from said first chamber into said second chamber to be mixed therein with said second fluid.
